(19) United States
(12) Patent Application Publication
(10) Pub. No.: US 2007/0282678 A1
(43) Pub. Date: Dec. 6, 2007

(54) PLATFORM TO ENABLE SHARING OF LOCATION INFORMATION FROM A SINGLE DEVICE TO MULTIPLE DEVICES IN RANGE OF COMMUNICATION

(75) Inventors: Vikram Dendi, Bellevue, WA (US); Zicheng Liu, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/421,713

(22) Filed: Jun. 1, 2006

(51) Int. Cl. G06Q 30/00

(52) U.S. Cl. 705/14

(57) ABSTRACT

The claimed subject matter can provide an architecture to facilitate widespread and economical access to location information as well as maintaining a healthy and robust location-based services ecosystem. The architecture can employ a variety of incentive mechanisms to encourage location-enabled devices to share location information with other devices that do not have location-enabled functionality. The incentives can also encourage novel uses for location-based services and/or promote new markets in that space. In addition, the architecture can employ techniques such as radiolocation to increase the accuracy of the location for the portable device relative to the known position of the location-enabled device.

### BACKGROUND

As use of and demand for mobile wireless devices increases, improvements in size, performance and functionality are constantly being developed and improved. Achieving the objectives of miniaturization and increased functionality continue to drive the portable wireless device industries toward improving numerous aspects of wireless devices including longer battery life, simplicity of use, connectivity, compatibility and added functionality. As wireless device use continues to increase there is an ever increasing demand to incorporate features found on other devices into a multifunctional singe unit, for example, many cell phones also function as a Personal Digital Assistant (PDA). Some of the features and/software applications running on wireless devices today rely on the utilization of location information.

Accordingly, it is becoming more and more useful to have universal and economical access to location information. Several technologies exist that allow a device to determine its location. For example, many devices can utilize the 24 active satellites which make up the United States' Global Positioning System (GPS) satellite constellation. In recent years, other technologies have been developed to enhance GPS such as Differential GPS, Wide Area Augmentation System, Local Area Augmentation System (LAAS), Carrier-Phase Enhancement GPS (CPGPS), Wide Area GPS Enhancement (WAGE), and many other enhancement services.

In addition to the United States' satellite constellation, the Russian Global Navigation Satellite System (GLONASS) are currently under development. As well, the European Union has a proposal for the Galileo positioning system as an alternative to the U.S. based GPS. There are many examples of complimentary technologies, such as the European Space Agency's European geostationary navigation overlay system (EGNOS) which augments the GPS and/or GLONASS services in various ways. In addition to the many possible location based services that are in development, there are multiple technologies that utilize the same service for increasing accuracy.

To complement the several existing satellite-based location services, many terrestrial-based location technologies have been developed as well, such as Long Range Navigation (LORAN). Also, there are several technologies for determining the location of a wireless device utilizing radiodetermination techniques. Cellular phone location determination can be achieved using radiolocation techniques as angle of arrival (AOA), time difference of arrival (TDOA), or location signatures. These technologies, including radiolocation, radionavigation, and other technologies may assist a device in determining its location. Location-based devices can operate in a passive manner, such as when listening to a GPS satellite signal, or may operate in an active manner, such as replying to a TDOA-based signal.

Utilizing these technologies does come at a cost, and conventionally, the cost has been too high to allow full capitalization of the location information market. For example, receiving signals may increase the size and price of a device because of the increased circuitry. In addition, some of the location technologies require the use of a special kind of receiver that may require the addition of an antenna or antennae. The increased circuitry, increased computational expense, increased memory requirements, and possible inclusion of additional antennae may make utilization of location based services less attractive. These issues may increase device cost, shorten useful battery life, make miniaturization more difficult, as well as other difficulties.

Moreover, the rapid change in portable device technology and the ever evolving location based technologies creates an environment in which it is especially difficult for manufacturers of portable devices to decide which particular technology to implement. Further, the rapid pace of these industries makes it difficult for various implementations of location based services to establish a reliable position in the marketplace. Accordingly, there is a need in the marketplace today to set up a robust, location based services ecosystem in which there is universal and economical access to location information that is independent of current location determining technologies.

### SUMMARY

The following presents a simplified summary of the various embodiments in order to provide a basic understanding of some aspects presented herein. This summary is not an extensive overview of the various embodiments. It is intended to neither identify key or critical elements nor delineate the scope of the embodiments. Its sole purpose is to present some concepts in a simplified form as a prelude to the more detailed description that is presented later.

The claimed subject matter disclosed and claimed herein, in one aspect thereof, comprises an architecture that can facilitate the development of a widespread and robust location-based ecosystem in which the ecosystem is easily adaptable to new developments in location-based technologies and can easily incorporate new and/or disparate location-based services. The system can include a location enabled device that is aware of its own position and can act as a “beacon” for portable electronic devices in proximity. In particular, the location enabled device can communicate location information with the portable electronic devices in range. This location information can be, e.g., an area defined by transmission range centered at the location of the location-enabled device. Additionally or alternatively, the system can utilize radiolocation technologies to give the portable electronic device more accurate information as to its own location, e.g., relative to the location-enabled device.

In accordance therewith, if, for example, a portable electronic device is utilizing a service or software package that helps a user arrive at a particular destination (e.g., mapping software), the accuracy of the location information does not need to be as accurate as what is available for GPS-based devices. Therefore, a portable device can communicate with a location-enabled device to get a reasonable estimate of its own position. By employing known wireless technologies (e.g., Bluetooth-brand technologies) a communication channel for location information sharing can be established. The communication channel can be employed both to transmit the location information as well as complete an incentive transaction in exchange for the information. Moreover, based on the specification for the wireless technologies employed, the transmission range can be known as well. Accordingly, the portable device can immediately know its own location within the accuracy of the positioning technology employed by the location enabled device (e.g., GPS) and within a circle of that device that has a radius equal to the maximum range provided by the specification of the wireless technology employed.

The accuracy can be further improved by leveraging techniques for wireless fidelity (WiFi) networks or radio frequency (RF) networks, such as WiFi and/or RF triangulation based positioning, radiolocation and/or the like. Hence, triangulation can be employed to communicate more accurate position information to multiple portable devices. As such the accuracy of the location information can be limited only by the precision of the positioning technology employed by the location enabled device (e.g., GPS) and the precision of the triangulation/radiolocation technology employed. Moreover, the manner in which the location of the portable device is ultimately determined is not limited to a single technology. For example, the position location can be determined based upon GPS, assisted GPS, cell sector-based lookups, etc. and the communication channel for sharing this information can employ, e.g., WiFi, Bluetooth-brand protocols, or substantially any other suitable communication protocol(s).

It is to be appreciated that the location enabled device can be implemented as a beacon, access point and/or gateway for the portable devices. Moreover, the communication channel established between the location-enabled device and the portable device(s) need not be limited to location information. For example, the location information channel may be part of a set of sessions, such as Internet access, e-commerce, etc. Therefore, the location enabled device could, e.g., provide Internet access to the portable device(s) (e.g., by way of WiFi) as well as other services.

According to one aspect of the claimed subject matter, the location enabled device (e.g., a kiosk) can be set up by a city government or private company to ensure that the general populace and tourists have access to location information. By employing this kiosk/beacon approach, the position of the kiosks can be determined to a high degree of accuracy and fixed in a location that does not change, so once the position is determined, no location service need be required for the kiosks. As such the kiosks can be constructed inexpensively at many locations throughout an area. The kiosks could, in effect, be providers of location information, receiving compensation in exchange for the services, or simply as a free service. In addition to the features mentioned above, the kiosks can provide additional radiolocation techniques that may be too cumbersome to place within many portable devices.

In accordance with another aspect of the claimed subject matter, the ecosystem can utilize a peer-to-peer model. For example, a first portable device can have a location information session in which location enabled devices will share its location with a second portable device, e.g., in exchange for an incentive provided by the second portable device and/or a third party. Accordingly, the incentive can be employed to entice users of location-enabled devices to share their location with others. This may be useful in a crowded area in which several location-enabled device may pass a portable device with enough frequency to be useful.

It should be understood and appreciated that the system can be independent of communication technologies utilized, and therefore is not limited to reliance upon a single technology. However, the system can also be designed to leverage existing technologies efficiently. Some communication technologies that may be employed include, e.g., those associated with WiFi, RF, Bluetooth-brand, Infared Device Association (IrDA), and the like. Varying technologies may have varying transmission ranges and/or accuracies for radiolocation purposes, but any suitable technologies for use with what is described herein may all be implemented and is contemplated to be within the spirit and scope of the claimed subject matter.

In accordance with another aspect, the location-sharing sessions may be initiated in a “pull” or “push” fashion. In a pull system, a portable device can query a location-enabled device for an initiation of a location sharing session. In a push model, the location enabled device may broadcast its desire to initiate a location sharing session. A passing portable device can then be given the opportunity to make use of this service. The broadcasted (e.g., pushed) service may include information as to what kind of incentive the location enabled device may require before it will share its location and may include such information as accuracy and how it is determining its location (e.g., GPS, AGPS, LORAN . . . ). This may utilize an existing advertising service technology or may be implemented based upon individual preferences.

According to another aspect of the claimed subject matter, an incentive can be exchanged for the location information. Some of the incentives that may be exchanged for access to location information (irrespective of how the location information is obtained) may be, e.g., money or some other medium of exchange, accepting a location-based advertisement, an account credit, a rewards program or the like. The currency-based incentives may be exchanged automatically, or may be exchanged by transferring money from one account to another. Another possible incentive that may be exchanged could simply be a right. For example, if a user was willing to entertain an advertiser's ad (e.g., with an associated coupon) in exchange for location information, the ad/coupon based upon the location of the portable device may be displayed on the screen of the portable device. Since this advertising mechanism can be advantageous to local businesses, there is a strong incentive for a local business to setup a kiosk type system so that a passerby may be apprised of that store's products/services when in proximity to the store.

According to another aspect of the claimed subject matter, the incentive may be a resale right. The incentive exchanged can be a right of the location enabled device to utilize some information gathered about a particular portable electronic device. For example, a location provider may collect information as to how many people pass a certain location per hour. Using statistical methods, an approximation can be made based upon how many portable devices pass by and request location information. In addition or alternatively the portable electronic device may provide other information such as user name, home address, phone number, or other information that a location reseller may want and a user of a portable electronic device is willing to exchange for use in one aspect of the claimed subject matter. This information may be utilized by marketing firms and/or local businesses.

Also, the item of exchange may relate to some other service and/or game. For example, a dating service may be willing to provide a portable device with location information in exchange for a willingness to view a profile of another person that is in the area with a high degree of correlation between the two users' dating profiles. The location information may utilize some other service such as accessing an Internet site that utilizes location information.

The following description and the annexed drawings set forth in detail certain illustrative aspects of the disclosed embodiments. These aspects are indicative, however, of but a few of the various ways in which the principles of the embodiments may be employed and the subject disclosure is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a system that can provide convenient and economical access to location information.

FIG. 2 depicts a block diagram of a system that can provide an incentive to share location information in order to, e.g., facilitate a robust location-based ecosystem.

FIG. 3 depicts a system that can exchange location information utilizing a location sharing protocol.

FIG. 4 illustration of a system that can include a location enabled device that utilizes GPS to obtain its location and a portable electronic device that can provide for location information over a datalink in exchange for an incentive.

FIG. 5 is a block diagram illustration a system that utilizes a pull transaction in order to establish location information sharing.

FIG. 6 is a block diagram illustration a system that utilizes a push transaction in order to establish location information sharing.

FIG. 7 is a block diagram of a system that can advertise its location sharing service and can also utilize radiolocation technologies to increase the accuracy of the location information.

FIG. 8 is an illustration of a system that can exchange location information in a peer-to-peer fashion.

FIG. 9 is a block diagram of a system that can exchange advertisement rights for location information and can display the advertisement on a portable electronic device.

FIG. 10 is a block diagram of a kiosk-based system that can advertise its location sharing services and can utilize additional technologies to increase the accuracy of the location information.

FIG. 11 illustrates an exemplary flow chart of procedures for facilitating location-based services for devices that are not location-enabled.

FIG. 12 illustrates an exemplary flow chart of procedures for facilitating location-based services with enhanced location accuracy.

FIG. 13 illustrates a block diagram of a computer operable to execute the disclosed architecture.

FIG. 14 illustrates a schematic block diagram of an exemplary computing environment.

### DESCRIPTION

The various embodiments are now described with reference to the drawings, wherein like reference numerals are used to refer to like elements throughout. In the following description, for purposes of explanation, numerous specific details are set forth in order to provide a thorough understanding of the various embodiments. It may be evident, however, that the embodiments may be practiced without these specific details. In other instances, well-known structures and devices are shown in block diagram form in order to facilitate describing the embodiments.

As used in this application, the terms “component,” “module,” “system” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion, but not to limit the scope of the disclosure or the appended claims to a particular embodiment. In addition, the words “accurate”, “accuracy” or “accurately” as used herein in reference to a position and/or location of a portable device can mean the position and/or location is determined to a higher degree of precision than relying upon the position of a location-enabled device. For example, the utilization of radiolocation can more accurately determine the location of the portable device.

As used herein, the terms to “infer” or “inference” refer generally to the process of reasoning about or inferring states of the system, environment, and/or user from a set of observations as captured by way of events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Inferences can also be based on statistical (e.g., probabilistic or Bayesian) models, fuzzy logic systems, artificial neural nets, or any combination of these.

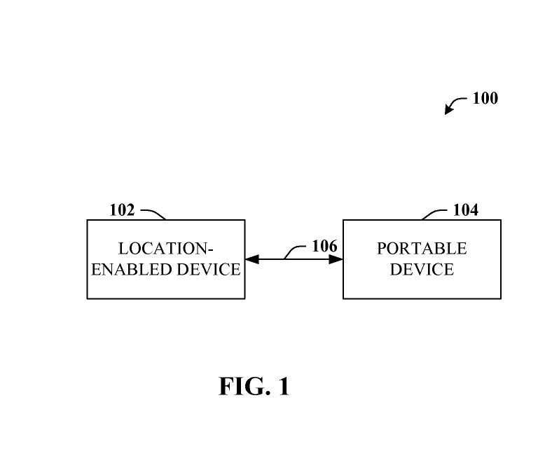

Referring now to the drawings, FIG. 1 depicts a system 100 that can provide widespread and economical access to location information. Generally, the system 100 can include a location-enabled device 102 that can communicate with a portable device 104, for instance, by way of a communication channel 106. It is to be appreciated that while components 102-106 are depicted in the singular, multiple instances of the components 102-106 can exist. As such, components 102-106 can be referred to either collectively or individually even though each instance of component 102-106 can have properties that distinguish them from other instances of component 102-106. For example, the location-enabled device 102 can communicate with one or more portable devices 104 and establish a communication channel 106 with each of the portable devices 104. Similarly, a portable device 104 can communicate by way of many respective communication channels 106 with many location-enabled devices 102.

The location-enabled device 102 can be substantially any device in which the location/position of the location-enabled device 102 is known or can be readily determined. For example, according to one aspect of the claimed subject matter, the location-enabled device 102 can be equipped with a location technology to determine the position of the location-enabled device 102. Such location technology can be but is not limited to, e.g., global positioning system (GPS), assisted GPS, global system for mobile communications (GSM) localization, or some other manner for determining location.

Additionally or alternatively, the location-enabled device 102 can be programmed with location information in a suitable format such as a street address, navigational coordinates (e.g., longitude and latitude), and the like. It is to be appreciated that the location-enabled device 102 can also be equipped with a conversion mechanism (not shown) (e.g., a software package, application, server query . . . ) to convert one format of location information into another. Thus, the location-enabled device is much more flexible not only in what types of location information can be accepted, but also maintains a richer interface that is compatible with virtually any other component (e.g., the portable device 104, third-party devices (not shown), applications that utilize location-based information (not shown), or the like).

Furthermore, the location-enabled device 102 can be designed to be stationary, quasi-stationary, or fully portable. For example, the location-enabled device 102 can be included in a kiosk (generally stationary), a home computer (quasi-stationary), or a mobile device such as a cell phone, personal digital assistant (PDA), etc. Typically, a fully portable location-enabled device 102 will employ one of the location technologies described supra in order to ascertain the current location. However, in some circumstances, even portable devices can be manually programmed with location information which can be employed in accordance with the claimed subject matter. Likewise, since most location technologies require a fee for providing location information, a stationary or quasi-stationary location-enabled device 102 need not incur these charges as this information can be programmed; incur the charge only once as the stationary location-enabled device 102 is installed; or a small number of times such as when a quasi-stationary location-enabled device 102 changes location.

It is to be appreciated that when the location-enabled device 102 is manually programmed with its location, there exists the potential for an error and/or misleading information. Therefore, in accordance with one aspect of the claimed subject matter, certain location-enabled devices 102 (e.g., those that do not obtain their current location by way of an established and/or error-free mechanism) may be required to conform with a rating system or other technique designed to ensure quality control. For example, location sharing requests can be occasionally monitored and/or verified for accuracy (e.g., by a party willing to provide an incentive). Location-enabled devices 102 that fail these safeguards will likely not be acceptable to portable device 104 users who might consume the location information or to a third party who can benefit from the dissemination of the location information.

Still referring to FIG. 1, since the location-enabled device 102 is aware of its own position, this position information can be employed, e.g., to determine the position of other devices (e.g., portable device 102) within range of the location-enabled device 102. In accordance therewith, the location-enabled device 102 can be substantially any device that can establish a suitable communication channel 106 with one or more portable devices 104 in order to determine and/or share location information. In essence, the location-enabled device 102 can inter alia act as a beacon for portable devices 104 and, e.g., share location information with the portable devices 104 that, e.g., do not have a subscription to a location service or otherwise do not know the appropriate location information or do not know the appropriate location information within a specified precision and/or format.

As such, the location-enabled devices 102 can be included in one or more kiosks erected by, e.g., a local government, a private company, or some other entity. The location of the kiosk can be in public environments such as a town square or tourist attraction, in commercial settings such as a theme park, store or mall, or on private property such as an individual residence that is, e.g., near a busy intersection. In the case of, e.g., a kiosk, the location-enabled devices 102 can be preprogrammed (since it is known) or established by employing one of the aforementioned or similar location technology subscriptions. Similarly, the location-enabled devices 102 can be included in, for example a home computer for which the owner knows the location (e.g., the street address). The claimed subject matter can also be employed in a peer-to-peer fashion, wherein the location-enabled device 102 is also mobile/portable such as a GPS-enabled cell phone, PDA, etc.

The connection channel 106 can include and/or incorporate various technologies or protocols, e.g., wireless fidelity (WiFi), RF, Bluetooth, Infared Device Association (IrDA), or any other suitable technology/protocol. Hence, in accordance with the kiosk-based approach, a Bluetooth (or other protocol) enabled kiosk can be employed, e.g., as a dedicated device (e.g., location-enabled device 102) that can broadcast a willingness to provide position information to any portable device 104 within range that are also equipped to enable Bluetooth (or other protocol) connection channel 106. In accordance with the peer-to-peer approach a first the location-enabled device 102 may only respond to requests from portable device 104 to provide location sharing information.

In particular, an exchange of location information can be effectuated as a result of a “push” or a “pull” transaction. Since retrieving position information from a location service is often a costly endeavor, stationary or quasi-stationary location-enabled devices 102 (e.g., a kiosk) are well suited to the push model since kiosks need not be constantly updated with a new position. In contrast, mobile location-enabled devices 102 are generally more suitable to a pull model since each sharing session can require a position update and associated costs. Hence, the mobile location-enabled device 102 can choose when to share location information, whereas a kiosk-based location-enabled device 102 will likely want to provide this information to as many portable devices 104 as possible.

It is to be appreciated that the location-enabled device 102 can also act as an access point and/or gateway for the portable device(s) 104 in addition to providing location-based services. Moreover, the communication channel 106 can also utilize a location sharing protocol on top of some other common protocol (e.g., Bluetooth) in order to efficiently handle certain location information operations discussed infra (e.g., negotiating terms of the location-sharing, etc.). It should also be appreciated that there are many RF networks already in place such as a car or home stereo that can receive RF data substantially anywhere on the planet, and these networks could also be employed for location-sharing services. For example, a location carrier signal can be embedded within standard radio signals broadcast from radio towers from a known location. By employing radiolocation techniques described herein, the radio receiver can extrapolate its own position. As such, a car stereo, for example can operate as a location-enabled device 102 and share this information with others.

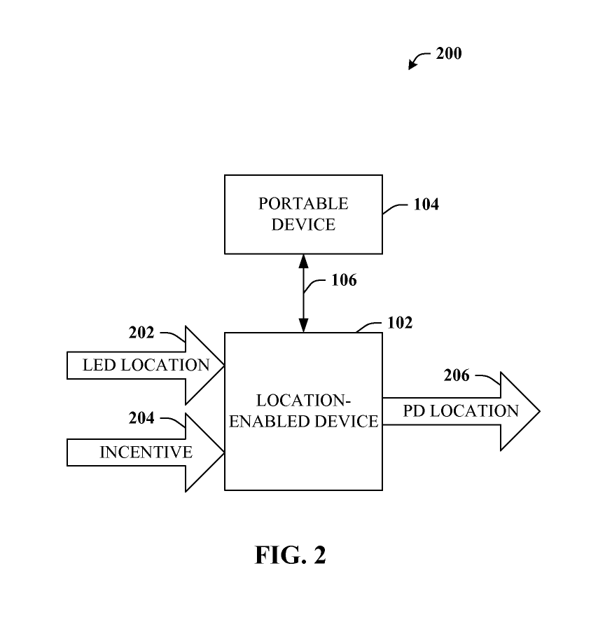

With reference now to FIG. 2, a system 200 that can provide universal and economical access to location information is depicted. The system 200 can, e.g., facilitate a self-sustaining, self-reinforcing ecosystem that attracts participants by way of incentives and can more fully utilize the full potential of location-based services. Generally, the system 200 can include a location-enabled device 102 that can communicate by way of a communication channel 106 with a portable device 104, as substantially described with reference to FIG. 1. The location-enabled device 102 can be a device that is aware of its own location, e.g., by way of LED location 202. LED location 202 can be provided by a location service such as GPS or similar service or manually input and typically represents the current position of the location-enabled device 102. Since providing location information is often associated with costs (e.g., the cost of obtaining location information itself or constructing a kiosk even when there is no cost or marginal costs associated with obtaining location information), the system 200 can also include an incentive 204.

The incentive 204 can be employed, e.g., to encourage location-enabled devices 102 to share location information even when there might otherwise be no other motivation for a suitable device to operate as a location-enabled device 102. Therefore, the incentive 204 can attract, e.g., “resellers” of location information, which can increase the market penetration and/or availability of location-based services without a large capital investment. By increasing the availability, the convenience to (and participation from) consumers of the location information can be increased, which, in turn, can foster new markets and a healthy and robust location-based ecosystem.

Accordingly, the incentive 204 can be substantially any mechanism to encourage the exchange of location-based information and/or services. The incentive 204 can also be limited to mechanisms that encourage location information sharing by a party (e.g., location-enabled device 102) who is otherwise not benefited by the sharing. For example, in the latter case, a company that provides location based services to its users is inherently benefited in a natural quid pro quo. As such, providing the service itself (e.g., in exchange for payment) is not necessarily considered to be an incentive 204 within the spirit and scope of the claimed subject matter, even though a monetary exchange involving a reseller of location information might be.

According to an aspect, the incentive 204 can be a monetary exchange. The monetary exchange can be, e.g., an automatic transaction from one bank account to another, for which issues relating to authentication, security and the like are known in the art. For instance, identity and/or authentication information can be provided by way of the communication channel 106 and the monetary transaction can be securely performed with by way of a secure Internet connection (not shown). The incentive 204 can also be a right rather than a direct economic benefit.

For example, the location-enabled device 102 may not have access to a location service in all areas. Thus, e.g., in exchange for voluntarily sharing location information with portable device(s) 104 that are in range while location-enabled device 102 is within a covered area, a reciprocal right to receive location information can be established (e.g., when outside the coverage area). Additionally or alternatively the right could entitle the location-enabled device 102 to receive more precise location information that could be required for certain applications. The incentive 204 can also be a right to display an advertisement on the portable device 104. For instance, a store kiosk can act as a location-enabled device 102 and can share location information with any portable device 104 that is in close proximity to the store in exchange for viewing an advertisement and/or coupon. Since the portable device 104 consuming the location information (and the ad) is certain to be in close proximity to the store the incentive 204 can create a viable form of target marketing (e.g., marketing to potential customers for which it is both more likely and convenient to shop while the advertisement is fresh in the mind).

In accordance with another aspect of the claimed subject matter, the incentive 204 can be an information resale right. For example, location-enabled device 102 may log certain demographic information related to portable devices 104. The portable device 104 may be willing to provide, e.g., information such as user name, home address, phone number, hobbies, interests or other information in exchange for being granted the location data. This demographic information may be utilized by the operator of the location-enabled device 102 directly, or resold to marketing firms and/or local businesses.

Additionally, the incentive 204 can be employed in connection with other services. For example, a dating service may be willing to display profile information for all or a subset of its members currently within close proximity to the location-enabled device 102 in exchange for sharing location information with other members of the dating service that, e.g., do not have a location-enabled device 102 but do have a portable device 104. Accordingly, the owner of the location-enabled device 102 may be willing to incur a charge for discovering the current position (or take the time to manually input the location) and freely communicate this location information with other dating service members in range. The dating service can then be informed of the position of the location-enabled device 102 and by proxy the location of portable device 104 users in close proximity (e.g., when they respond to the beacon). Moreover, portable device 104 can be supplied with similar profile information in exchange for responding to the beacon provided by location-enabled device 102 and/or in exchange for a willingness to view a particular profile of another person that is known to be in the immediate vicinity and optionally matches the dating profile. The location information may utilize some other service such as accessing an Internet site for additional information.

Another example that may facilitate the development and maintenance of a vibrant location-based ecosystem involves the use of reward points. A stationary or quasi-stationary location-enabled device 102 typically knows its own location, but normally has no incentive to share this information with portable devices 104. However, a location-based service provider may promote the use of its products or services by supplying reward points to those who act as a location-enabled device 102 and share information with portable devices 104. For example, a home computer acting as a location-enabled device 102 knows its location and can provide this information to portable devices 104 in exchange for earning reward points. The reward points can be redeemable, e.g., for products or services offered by the incentive 204 provider or a third party.

In another aspect of the claimed subject matter, incentive 204 can include access rights such as a right to access features/software found on portable device 104. For example, incentive 204 can entitle the location-enabled device 102 the right to access and/or to execute code on portable device 104 for a certain period of time. This access right could be utilized to place custom advertisements on portable device 104. The access right could be a Flash-brand presentation, or may be some other system in which the user of portable device 104 has authorized. For example, if a user of a cellular phone, as illustrated by portable device 104, enters a mall, the user may come within close proximity to a department store. A kiosk style location-enabled device 102 can be situated near the entrance of the department store. The two devices can initiate an exchange by way of communication channel 106 and the kiosk may inform the cellular phone of GPS position information (or similar information that can be converted). If, in this example, the exchange takes place utilizing Bluetooth, the cellular phone knows that it is within a 100 meters and more likely is within 10 meters (depending on the power rating employed). The cellular phone may utilize this information for record keeping purposes or may use the information to emulate a GPS device in which other software may access the information, just as if the cellular phone was equipped with a hardware GPS receiver.

In exchange for this information the cellular phone, in this example, may run an application for 30 seconds. In effect, in exchange for location data, the cellular phone agrees to run a type of commercial. The code may include a jingle, music, graphics and information about the department store trying to entice the user to come inside the store. In addition, the software may display a link during the “commercial” in which the user can click on the link to either access a coupon, obtain more information, or otherwise interact with the software in such as way that will likely entice the user to purchase something from the department store.

In accordance with another aspect of the claimed subject matter, the location-enabled device 102 can transmit PD location information 206 that relates to the position of the portable device 104. The PD location information 206 can be transmitted to the portable device 104 as described supra, and/or to other devices (not shown). For example, the portable device 104 may have authorized or be required to provide its current whereabouts to the other devices. In one example, such an authorization can implicitly act as the incentive 204 and the PD location 206 can be delivered to the portable device 104 in exchange for the right and/or authorization to deliver PD location 206 to other devices as well. In another example, the portable device 104 can be specially designed, e.g., for children and equipped with, e.g., a parental control option that authorizes transmitting the PD location 206 to the other device (e.g., a device that can be accessed by a parent). As such the incentive 204 can be provided by the other device and the location-enabled device 102 can transmit PD location information 206 to verify that the portable device 104 is within a designated range of the location-enabled device 102 and/or that the portable device 104 has left the designated range from location-enabled device 102.

Furthermore, the PD location 206 can be more accurate with respect to the location of the portable device 104 than is the LED location 202. For example, the location-enabled device 102 can employ the LED location 202, employ known transmission range information for the communication channel 106 and determine a radius in which the portable device generally must be. However, in addition, the location-enabled device 102 can also employ techniques such as radiolocation in order to more accurately establish the PD location 206. In particular, the location-enabled device 102 can employ a signal strength indicator mechanism to establish an angle of arrival for signals received (e.g., by way of communication channel 106) from the portable device 104; and a mechanism to determine transmission time to establish the distance. In tandem, these two mechanisms can be employed to accurately determine the PD location 206 relative to the location-enabled device 102. It is also to be appreciated that the radiolocation mechanism can reside on the portable device 104, in which case the appropriate measurements and calculations can take place on the portable device 104 rather than on the location-enabled device 102.

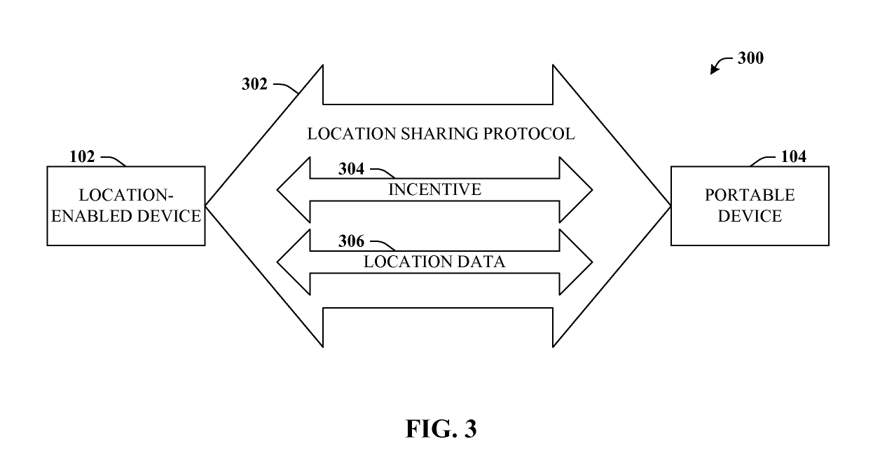

Turning now to FIG. 3, a system 300 that can exchange location information utilizing a special protocol is depicted. In general, the system 300 can include a location enabled device 102 and a portable device 104 that communicate utilizing a location sharing protocol 302. The location sharing protocol 302 can be especially suitable for certain transaction, such as transactions relating to incentive 304 negotiation/acceptance, sharing of location data 306, or the like. Incentive 304 can be substantially similar to incentive 204 discussed in relation to FIG. 2. Likewise, the location sharing protocol 302 can exist within other protocols (e.g., communication channel 106 from FIGS. 1 and 2), or layer, and/or may encapsulate other layers.

The location sharing protocol 302 may rely on existing infrastructure, such as WiFi networks or the Internet, and may create new infrastructure where the functionality may be inadequate or nonexistent. For example, the protocol may utilize TCP/IP to implement location sharing protocol 302 and may provide interfaces within the protocol so that incentive information layer 304 can communicate with other layers, such as location data 306. The interface may facilitate horizontal or vertical communication. Additionally or alternatively, the location sharing protocol 302 can be a connection-based protocol or a connectionless protocol. As well, location sharing protocol 302 may be packet based or circuit based, including, e.g., virtual circuits. The models in which the various layers may be based upon can include Open System Interconnection (OSI) Reference Model, an IEEE 802 layer, TCP/IP, or some other network model or technology.

For example, location sharing protocol 302 can exist on an OSI model by being implemented as a Layer 7 application layer. The location sharing may operate in a manner similar to Telnet, FTP, or SMTP and may provide high level communication. The protocol may have encryption integrated into it for security and authentication and/or verification as well. High level commands may dictate when a device is willing to receive incentive information and/or location data. For example, a portable device 104 can request location information from location-enabled device 102 by sending, e.g., the command “REQUEST LOCATION DATA”. The location-enabled device 102 may reply back, e.g., “LOCATION DATA INCLUDES LAT/LONG WITHIN 2 METER ACURACY/UTILIZING AGPS/INCENTIVE IS 30 SECOND JAVA APP”. The portable device 104 may not be equipped with a Java runtime engine and may reply back “TRANSACTION CANCELLED”or, in the alternative, the portable device 104 may be so equipped and the terms acceptable to the user, in which case the response could be “TRANSACTION ACCEPTED”.

The above sequence may be sent utilizing several technologies for communication such a WiFi, Bluetooth, or IrDA. The above example illustrates that the protocol is independent what technologies it utilizes for transmission of the commands. In addition, the protocol may be independent of how the location enabled device obtains location data. For example, portable device 104 may only process information about the accuracy and may not care how the information was obtained, or alternatively may ignore the fact that location-enabled device 102 utilized radiolocation to give portable device 104 more accurate location information.

In addition to the aspects described above, the accuracy may be incentive based as well. For example, for location information that has an accuracy of 2 meters, a 30 second commercial may run on portable device 104, while an accuracy of 0.25 meters may give the location-enabled device 102 (or a third party by proxy) the right to run a 2 minute commercial. The various aspects disclosed herein are not intended to be exhaustive or to limit the scope but are only intended to give one of skill in the art an appreciation of the several features of the claimed subject matter.

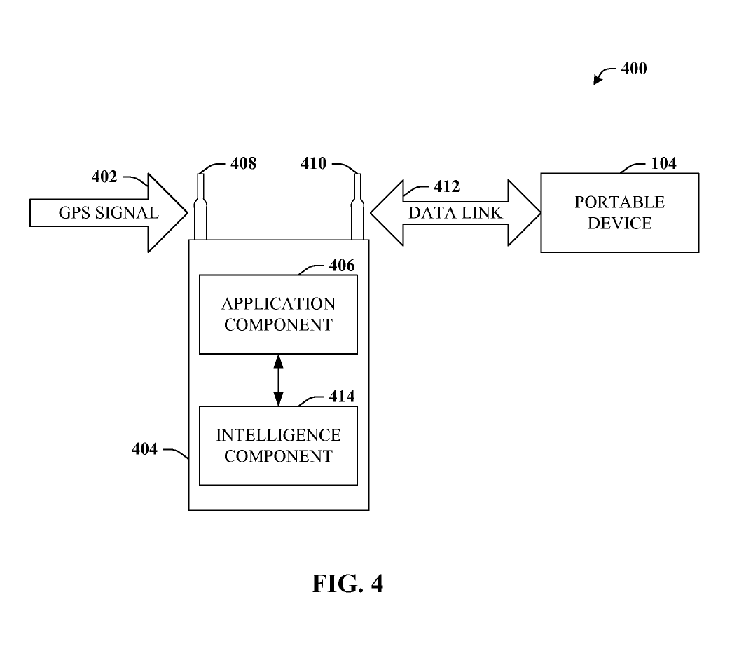

With reference now to FIG. 4, a system 400 that can include a location-enabled device that utilizes GPS to obtain its location and a portable device that can request location information over a datalink in exchange for an incentive is depicted. System 400 can generally include a portable device 104 and a location-enabled device 404. The location-enabled device 404 is depicted as a portable device, but may be in a fixed location, such as in the kiosk-based model. Location-enabled device 404 can include an antenna 408 which receives GPS signal 402 in a passive manner. In addition to the GPS receiving antenna 408, location-enabled device 404 can include a wireless transceiver that utilizes antenna 410. This may be a WiFi based transceiver, Bluetooth, or some other wireless technology. Additionally, location-enabled device 402 can contain an application component 406.

Application component 406 can be, e.g., software that is capable of being executed by location-enabled device 404. Application component 406 may be implemented in hardware, software, with the aid of a microprocessor, with the aid of RAM, or some combination thereof. Application component 406 can be controlled by communications from an operating system (not shown) or may include the operating system (OS). The OS can communicate with application component 406 by, e.g., utilizing system calls, software interrupts, hardware interrupts, exceptions, memory management units, shared memory, or other method of communication.

The behavior of application component 406 may include the ability to utilize datalink 412 to accomplish sharing location information and/or other aspects of a robust location-based ecosystem. Also, application component 406 can include the use of logging and/or data retention for use in, e.g., e-commerce applications, such as information reselling, marketing targeting, or with integration with an incentive mechanism. Additionally or alternatively, application component 406 may include processing related to the incentive exchange, such as the ability to send advertisements, code, receive money, create custom coupons, or other incentive related processing to facilitate the use of the system for the benefit of the ecosystem, and its participants.

In accordance with one aspect of the claimed subject matter, the application component 406 can include or be coupled to an intelligence component 414. The intelligence component 414 can, e.g., analyze any relevant data obtained by the location-enabled device 404, e.g., in the course of sharing location information, logging demographic information, etc. The intelligence component 414 can provide inferences about, e.g., a current incentive mechanism and thus modify or make suggested modification in order to enhance the ecosystem, for instance when the intelligence component 414 determines the current mechanism is not effective or can be improved. In general, the intelligence component 414 can examine the entirety or a subset of the data obtained or accessible by the location-enabled device 404 and can provide for reasoning about or infer states of the system, environment, and/or user from a set of observations as captured via events and/or data. Inferences can be employed to identify a specific context or action, or can generate a probability distribution over states, for example. The inference can be probabilistic—that is, the computation of a probability distribution over states of interest based on a consideration of data and events. Inferences can also refer to techniques employed for composing higher-level events from a set of events and/or data.

Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, where the hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

Still referring to FIG. 4, in accordance with one aspect, the intelligence component 414 can effectuate behavior targeting and/or dynamic marketing. For example, suppose that certain men between, e.g., 28 to 34 years old have a higher probability of shopping at a particular store after being presented with a particular advertisement/coupon (e.g., based upon an advertising right in exchange for location information). In that case, intelligence component 414 can suggest that the application component 406 begin to solicit requests for age and/or gender information, e.g., as part of an incentive. That is, the intelligence component 414 can infer whether the potential benefits of knowing this information to allow market targeting outweighs the potential negative aspects associated with requiring/requesting the personal information. Moreover, dynamic content may also relate to dynamic requests for incentives. For example, intelligence component 414 may dynamically determine what kinds of information that it finds valuable, and may change its requests as circumstances change. It is to be appreciated that many of these dynamic action may be preprogrammed as well, for instance, known demographic criteria that yields greater success of certain types of advertisements.

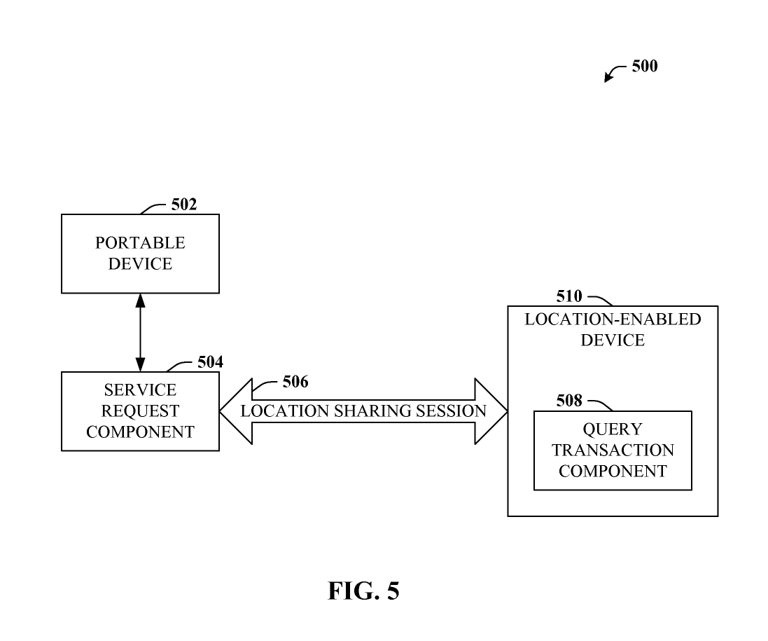

Referring now to FIG. 5, a block illustration of a system 500 that utilizes a pull transaction in order to establish location information sharing is depicted. Generally, the system 500 can include a portable device 502 and a location-enabled device 510. Service request component 504 can initiate a “pull” of the location-based service. For example, service request component 504 may transmit a request to location-enabled device 510, requesting initiation of a location information session 506. Location sharing session 506 may include existing protocols and/or interfaces or may utilize be a protocol specifically for location sharing sessions. Location-enabled device 510 can include query transaction component 508 that can respond to the request.

The query transaction component 508 can be programmed to react to pull requests from service request component 504. For example, the query transaction component 508 can be set to accept all pull requests, only those that meet certain criteria, or no requests at all. Moreover, the query transaction component 508 can be instructed to notify a user when a pull request does not meet the criteria necessary for accepting the pull request. For instance, a user may want to know the terms offered, even if the terms are different from the default programmed into the query transaction component 508. Similarly, even when a request from service request component 504 is refused by the query transaction component 508, the service request component 504 can notify the user of the device (e.g., portable device 504) that the terms were refused, as well as what terms would be acceptable.

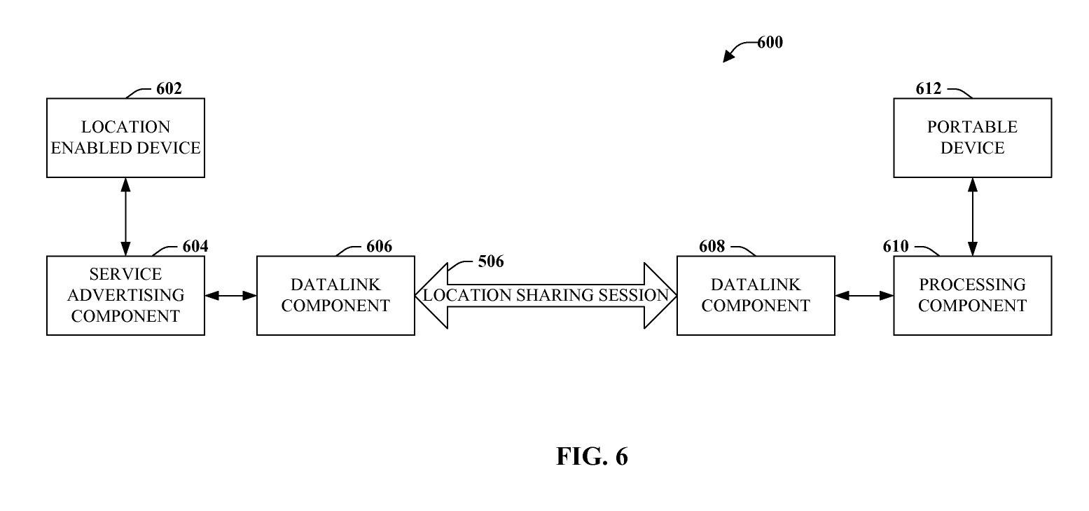

With reference now to FIG. 6, a system 600 that utilizes a push transaction in order to establish location information sharing is illustrated. In general, system 600 can include a location-enabled device 602 and a portable device 612. The location-enabled device 602 can continuously broadcast signals intended to indicate a desire to share location information with all or a subset of all portable devices 612 within transmission range. In particular, the location-enabled device 602 can notify all devices within broadcast range what services location-enabled device 602 has available as well as what the terms for accepting the push are. Location-enabled device 602 can include a service advertising component 604 that can communicate and/or control the operation of the “pushing”, e.g., by dictating to the datalink component 606 what information to transmit.

Push technologies, in general, are a content delivery technology. Rather than having a client device request to use a service from a server, a client, can instead, set a predefined set of request parameters to determine when it should receive information about a service. A major advantage of utilizing “push” technology is that the client device knows instantly when a service is available. In system 600, an exemplary client device is the portable electronic device 612. The “request parameters” can control what processing component 610 should do with data it receives regarding location information sharing services. Processing component 610 could drop the packets or could instead process them.

Location sharing processing component 610 can control the predefined set of “requests parameters” and can decide when to “listen” for location based broadcast services. The raw information can be transferred to it from the datalink component 608 although location sharing processing component 610 may ignore all information received by it or it may “listen” for location sharing services that, upon arrival, can notify other components (not shown) and/or the user of portable electronic device 612 that the service is available. An example of when location sharing services are processed by location sharing processing component 610 may be when a portable electronic device 612 has an on/off feature such that if a location sharing service is in range, an “on” setting will cause the device to beep. In this case, the predefined set of “request parameters” is whether or not a location sharing service is broadcasting a packet.

Once the portable electronic device 612 has received information relating to the location sharing service and has decided to utilize the service, location sharing session 506 can be established to facilitate the location information sharing transaction. The transaction then proceeds as described herein, and does not need to differ in any substantial way simply because a “push” technology was employed to in order to motivate the transaction.

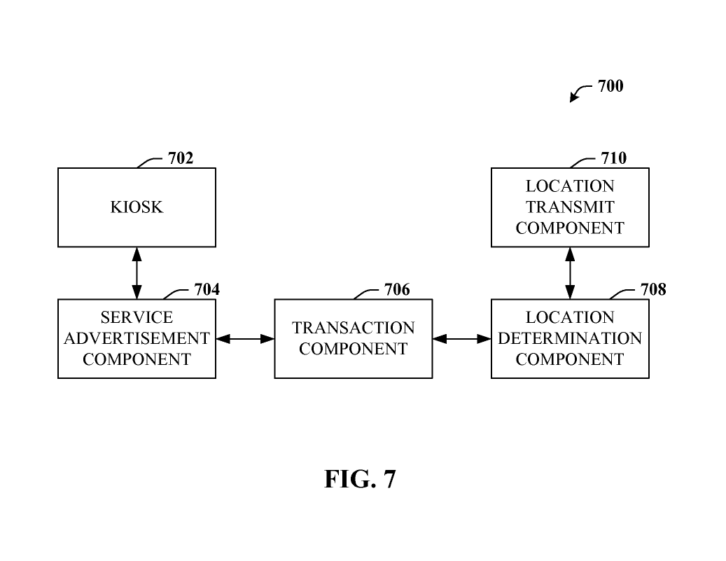

Referring now to FIG. 7, a block diagram of a system 700 that can advertise its location sharing service and can also utilize radiolocation technologies to increase the accuracy of the location information. System 700 can generally include a kiosk 702 that can promote the location sharing services. Service advertisement component 704 can control, e.g., the “push” features associated with the location service while transaction component 706 can handle the transactions involved with the service. Client location determination component 708 can employ additional location based technologies so that a portable device (not shown) can have access to more accurate location information than is otherwise possible. For example, client location determination component 708 can utilize technologies such as radiolocation or some other technology so that when location information is transmitted by location transmit component 710, the information that is sent to a portable wireless device can contain data associated with the actual position of the wireless device in addition to what is known about the location of kiosk 702.

Client location determination component 708 can employ radiolocation technologies such as triangulation by sending “ping” signals to a portable device. These signals can enable the kiosk 702 to gather a more accurate reading on the portable device. The client location determination component 708 may, for example, determine bearing and/or distance information of the portable wireless device and can determine the location of a portable wireless device with a level of accuracy that is difficult to achieve without utilize additional location technologies. Without employing more accurate location technologies.

As communication technologies progress, wireless devices have been evolving toward greater transmission distances. Thus, if a location based service is limited only to the location information associated with a location-enabled device (e.g., kiosk 702), then any improvement to wireless transmission range will proportionately degrade the accuracy of a location information system that relies solely upon the location of the location-enabled device. However, this difficulty can be avoided by employing technologies, such as radiolocation in conjunction with what is known about the location of other devices and/or transmission range specifications.

Moreover, increased accuracy associated with, e.g., radiolocation can easily be incorporated into the incentive-based ecosystem of the claimed subject matter. Therefore, the incentive employed to promote the architecture may be a direct function of the accuracy provided in the location information. For example, a user might require a higher degree of accuracy for a particular application, and thus be willing to agree to terms more favorable to another party in order to obtain the increased accuracy. As such the incentive-based aspects of the ecosystem are naturally promoted by free-market principals. This aspect, in effect, allows a location information provider to offset any costs associated with increased accuracy and will encourage the development of higher accuracy radiolocation technologies. It is to be understood that although the examples described herein with reference to system 700 have included radiolocation, any other technology that can aid in the determination of the relative and/or absolute location of a portable device will facilitate the ecosystem in a similar way and are contemplated to be within the spirit and scope of the claimed subject matter.

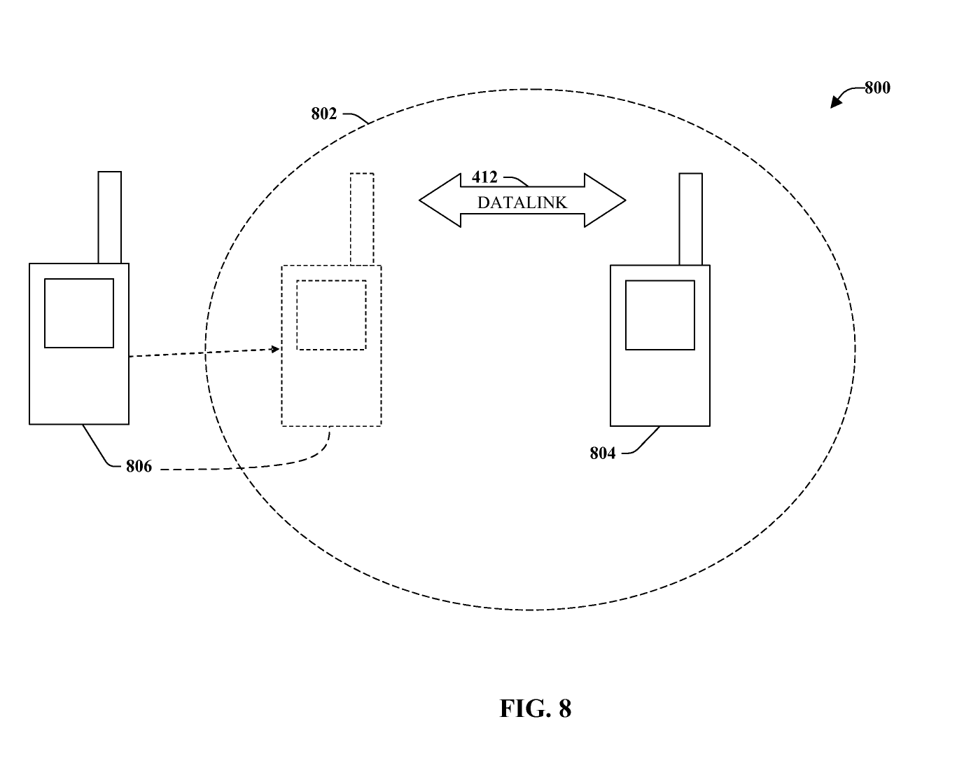

Turning briefly now to FIG. 8, a graphic representation of a location sharing session operating in a peer-to-peer fashion between two cellular phones is depicted. Typically, system 800 can include a radio range 802 in which cellular phone 804 (e.g., a location-enabled device) can successfully communicate wirelessly. When wireless device 806 (e.g., a portable device that is not location-enabled) enters into radio range 802, datalink 412 can commence a location sharing session.

In certain situation, peer-to-peer models may be the only suitable and/or available model. As such, the peer-to-peer-based system can compliment kiosk/client services by filling in the gaps of the location based ecosystem and may help ensure that the ecosystem is vibrant even in, e.g., remote and/or uncovered locations. For example, a kiosk need not exist in a location for location-based services to be available, since a portable location-enabled device can subsume a similar role.

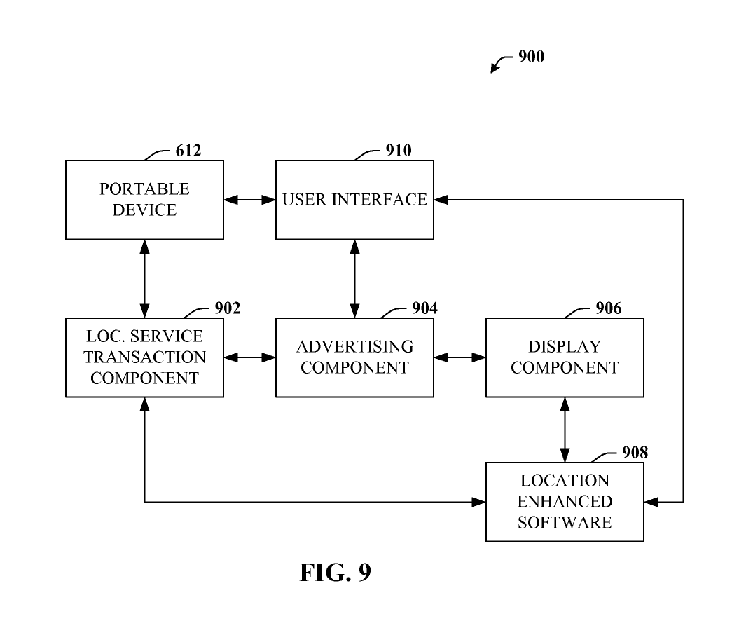

With reference now to FIG. 9, a block diagram of system that can accept advertisements on a portable electronic device in return for location information. Generally, system 900 can include a portable device 612 that can employ location service transaction component 902 to coordinate a location sharing session. Location service transaction component 902 can determine the location of the portable devices 612 that are in proximity and can transmit that information to advertising component 904. Advertisement component 904 can select advertisements that are desired to be transmitted to the portable electronic device 612 and displayed on display component 906.

Location enhanced software 908 can be substantially any software compatible with the portable device 612 and, ideally, something that a user of this location sharing ecosystem might benefit from receiving, such that an advertisement for the software would be desirable. For example, location enhanced software 908 may be mapping software, which is beneficial to the user of portable electronic device 612 in order to, e.g., find a particular destination. User interface 910 can allow a user to control interactions with location enhanced software 908 as well as the portable device 612, such as installing and running the software 908. In addition, the user interface 910 can facilitate interaction with the advertisement component 904 in order to, e.g., agree to accept a particular product/service and/or to view more information associated with the particular product/service.

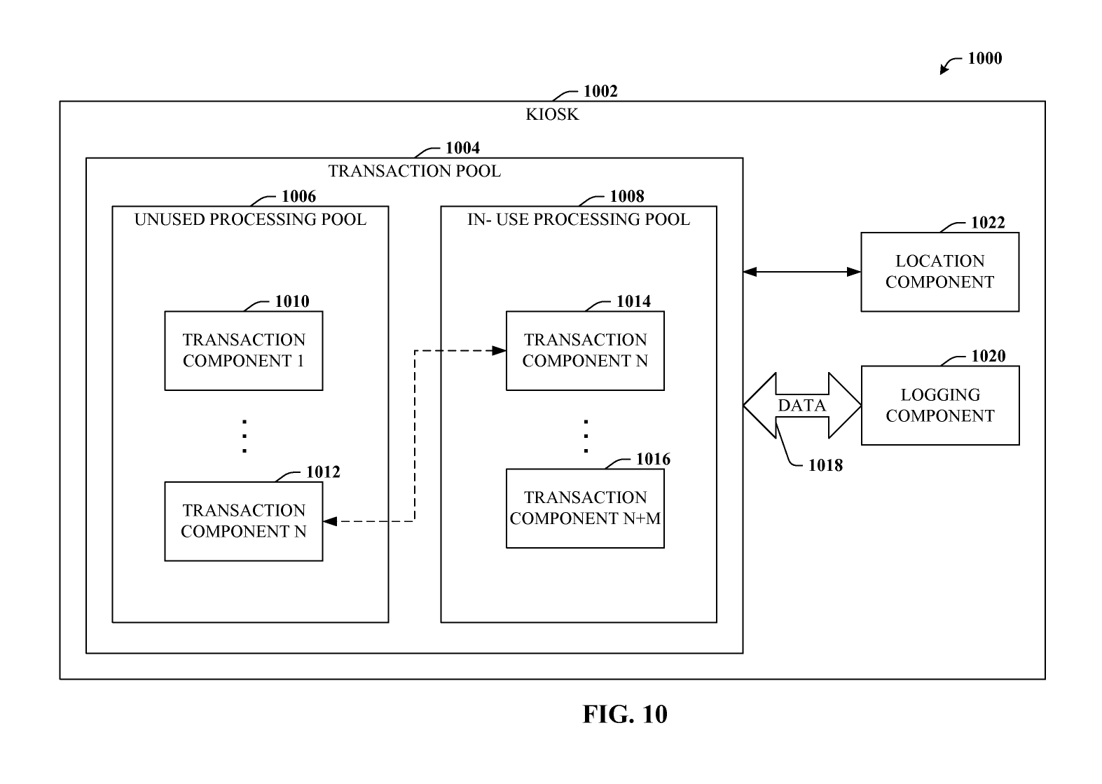

Referring now to FIG. 10, a system 1000 that includes a kiosk-type device that can advertise its location sharing services and can utilize additional technologies to increase the accuracy of the location information is depicted. In general system 1000 can include location-enabled kiosk 1002. Included in the kiosk 1002 is a software based transaction pool 1004. The transaction pool can be a collection of threads and/or process control blocks (PCB). Unused process pool 1006 can contain pointers to processes that are currently pointing to null, while in-use process pool 1008 can contain pointers to processes at memory locations with valid data. For the sake of brevity only transaction component 1000-1016 are illustrated, however, additional transaction components are possible.

When a portable device (not shown) requests location information from kiosk 1002, a process controller device takes up the transaction and relocates the transaction component associated with the request from the unused processes pool 1006 to in-use processes pool 1008. This is illustrated by the transition of transaction component 1012 to transaction component 1014. The currently used transaction components (e.g., 1014-1016) are included in the in-use process pool 1008, and the activities associated with these transactions can be transmitted by way of data path 1018 to logging component 1020. Location component 1022 can be employed to aid the transaction pool 1004 handle the location requests from portable devices.

In essence, a transaction server approach can be implemented on a location-enabled kiosk (e.g., kiosk 1002). Thus, a great deal of control over processing load can be afforded, by providing control over the number of transactions that kiosk 1002 can process at a given time. Moreover, the kiosk may only be able to accommodate a certain number of processes, but idle processes (e.g., transaction components 1012-1014) can be destroyed to accommodate a new process that is not idle (e.g., transaction components 1014-1016).

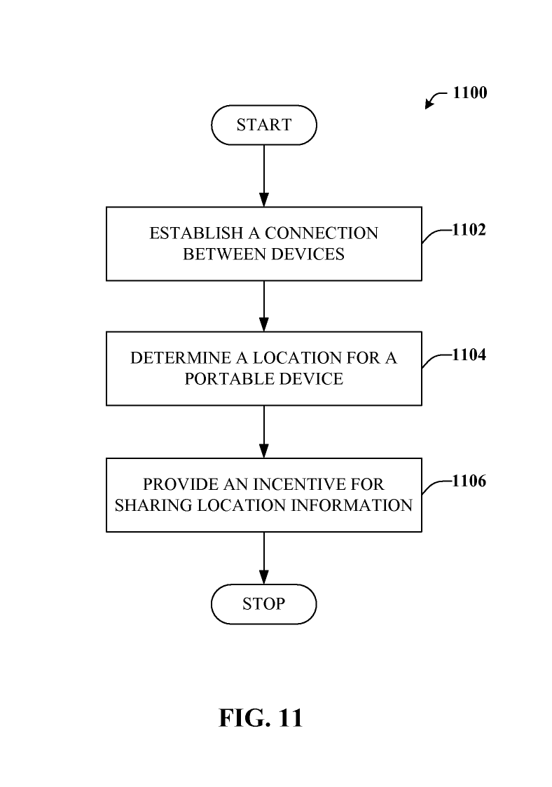

FIG. 11 illustrates a process flow diagram of a computer implemented method 1100 for facilitating location-based services for devices that are not location-enabled. While, for purposes of simplicity of explanation, the one or more methods shown herein, e.g., in the form of a flow chart, are shown and described as a series of acts, it is to be understood and appreciated that the subject invention is not limited by the order of acts, as some acts may, in accordance with the invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the invention.

At 1102, a connection (e.g., communication channel) can be established between a location-enabled device and a portable device. As described herein, the connection can be instigated by either a push or a pull transaction and the location-enabled device can be a kiosk or mobile device such as a cell phone or a PDA. Typically, the portable device will not be location-enabled, but may desire to receive location information, e.g., to ascertain the location itself and/or for use with other location-based services.

At 1104, the location of the portable device can be determined based at least in part upon the known location of the location-enabled device. Again, it is essential how the location-enabled device obtains its own location, e.g., by way of a location service such as GPS or by manually inputting the data. However, quality control assurances can be implemented to prevent false or inaccurate data relating to the location information request, especially in the case in which the location is manually input. At 1106, an incentive for sharing the location information can be provided, e.g., to encourage the participation and promote the health and effectiveness of a location-based services ecosystem. The incentive can take many forms, many of which have been described herein, however, an exhaustive list is not, of course, possible.

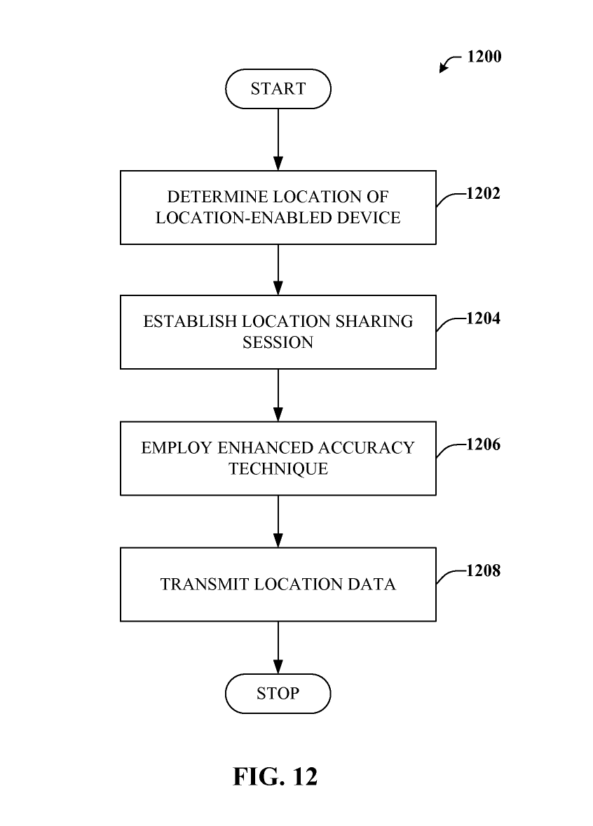

Turning now to FIG. 12, a method 1200 for facilitating location-based services with enhanced location accuracy is illustrated. At 1202, the location of a location-enabled device can be determined by using, e.g., GPS, manual location data entry or another suitable technique. It is to be understood that once the location of location-enabled device is determined the device can retain that location until the device has been moved. The location of the location-enabled device can be, e.g., employed as a starting point for portable devices within range of the location-enabled device to know their own location. At 1204, a location sharing session can be established in which location information and/or other location-based services, etc. can be facilitated.

At 1206, a technique for enhanced accuracy with respect to the location of the portable device can be employed. For example, radiolocation or other triangulation technique can be employed to more accurately establish the position of the portable device relative to the location-enabled device. Of course, other techniques are contemplated to be with the scope of the claimed subject matter. At 1208, data relating to the location of the portable device can be transmitted. Normally, this data is transmitted to the portable device that participated in the location sharing session, however, in certain circumstances, this information can be transmitted to other devices instead of or in addition to.

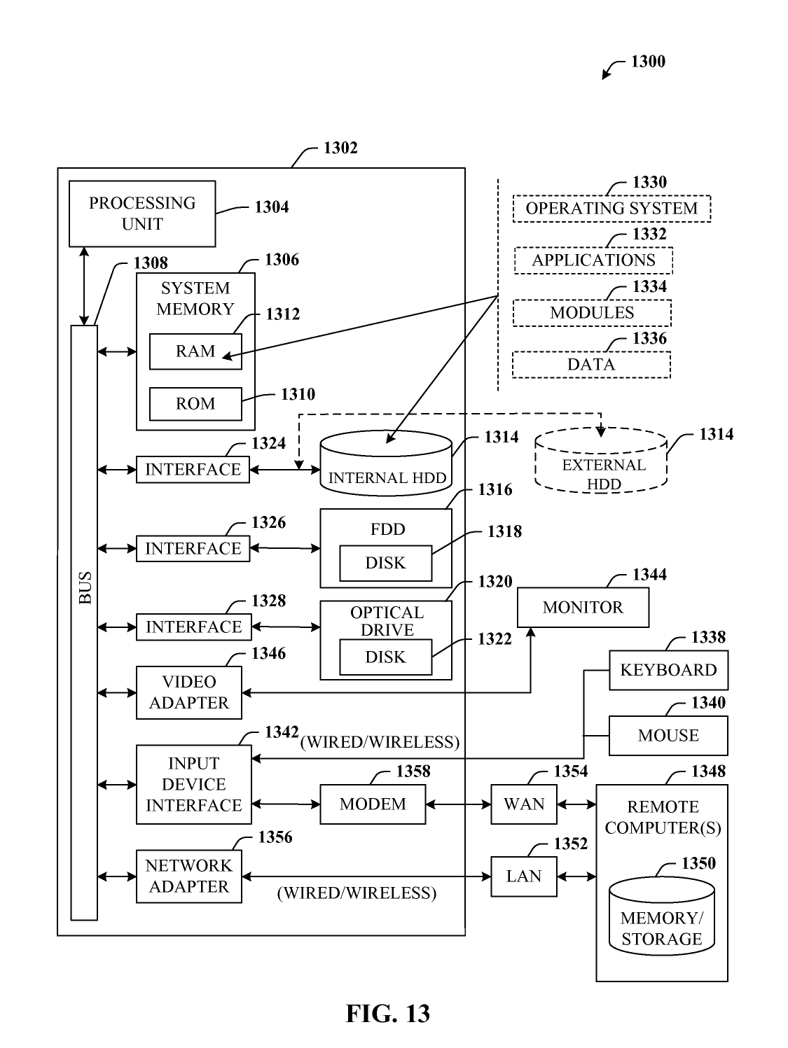

Referring now to FIG. 13, there is illustrated a block diagram of an exemplary computer system operable to execute the disclosed architecture. In order to provide additional context for various aspects of the claimed subject matter, FIG. 13 and the following discussion are intended to provide a brief, general description of a suitable computing environment 1300 in which the various aspects of the claimed subject matter can be implemented. For example, various components of the systems and/or aspects thereof described supra can be implemented by way of the system 1300. Additionally, while the claimed subject matter has been described above in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 13, the exemplary environment 1300 for implementing various aspects of the claimed subject matter includes a computer 1302, the computer 1302 including a processing unit 1304, a system memory 1306 and a system bus 1308. The system bus 1308 couples to system components including, but not limited to, the system memory 1306 to the processing unit 1304. The processing unit 1304 can be any of various commercially available processors. Dual microprocessors and other multi-processor architectures may also be employed as the processing unit 1304.

The system bus 1308 can be any of several types of bus structure that may further interconnect to a memory bus (with or without a memory controller), a peripheral bus, and a local bus using any of a variety of commercially available bus architectures. The system memory 1306 includes read-only memory (ROM) 1310 and random access memory (RAM) 1312. A basic input/output system (BIOS) is stored in a non-volatile memory 1310 such as ROM, EPROM, EEPROM, which BIOS contains the basic routines that help to transfer information between elements within the computer 1302, such as during start-up. The RAM 1312 can also include a high-speed RAM such as static RAM for caching data.

The computer 1302 further includes an internal hard disk drive (HDD) 1314 (e.g., EIDE, SATA), which internal hard disk drive 1314 may also be configured for external use in a suitable chassis (not shown), a magnetic floppy disk drive (FDD) 1316, (e.g., to read from or write to a removable diskette 1318) and an optical disk drive 1320, (e.g., reading a CD-ROM disk 1322 or, to read from or write to other high capacity optical media such as the DVD). The hard disk drive 1314, magnetic disk drive 1316 and optical disk drive 1320 can be connected to the system bus 1308 by a hard disk drive interface 1324, a magnetic disk drive interface 1326 and an optical drive interface 1328, respectively. The interface 1324 for external drive implementations includes at least one or both of Universal Serial Bus (USB) and IEEE 1394 interface technologies. Other external drive connection technologies are within contemplation of the claimed subject matter.

The drives and their associated computer-readable media provide nonvolatile storage of data, data structures, computer-executable instructions, and so forth. For the computer 1302, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. It is appreciated that the claimed subject matter can be implemented with various commercially available operating systems or combinations of operating systems.

A user can enter commands and information into the computer 1302 through one or more wired/wireless input devices, e.g., a keyboard 1338 and a pointing device, such as a mouse 1340. Other input devices (not shown) may include a microphone, an IR remote control, a joystick, a game pad, a stylus pen, touch screen, or the like. These and other input devices are often connected to the processing unit 1304 through an input device interface 1342 that is coupled to the system bus 1308, but can be connected by other interfaces, such as a parallel port, an IEEE 1394 serial port, a game port, a USB port, an IR interface, etc.

A monitor 1344 or other type of display device is also connected to the system bus 1308 via an interface, such as a video adapter 1346. In addition to the monitor 1344, a computer typically includes other peripheral output devices (not shown), such as speakers, printers, etc.

The computer 1302 may operate in a networked environment using logical connections via wired and/or wireless communications to one or more remote computers, such as a remote computer(s) 1348. The remote computer(s) 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1350 is illustrated. The logical connections depicted include wired/wireless connectivity to a local area network (LAN) 1352 and/or larger networks, e.g., a wide area network (WAN) 1354. Such LAN and WAN networking environments are commonplace in offices and companies, and facilitate enterprise-wide computer networks, such as intranets, all of which may connect to a global communications network, e.g., the Internet.

When used in a LAN networking environment, the computer 1302 is connected to the local network 1352 through a wired and/or wireless communication network interface or adapter 1356. The adapter 1356 may facilitate wired or wireless communication to the LAN 1352, which may also include a wireless access point disposed thereon for communicating with the wireless adapter 1356.

When used in a WAN networking environment, the computer 1302 can include a modem 1358, or is connected to a communications server on the WAN 1354, or has other means for establishing communications over the WAN 1354, such as by way of the Internet. The modem 1358, which can be internal or external and a wired or wireless device, is connected to the system bus 1308 via the serial port interface 1342. In a networked environment, program modules depicted relative to the computer 1302, or portions thereof, can be stored in the remote memory/storage device 1350. It will be appreciated that the network connections shown are exemplary and other means of establishing a communications link between the computers can be used.

The computer 1302 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a ) or 54 Mbps (802.11b ) data rate, for example, or with products that contain both bands (dual band), so the networks can provide real-world performance similar to the basic 10BaseT wired Ethernet networks used in many offices.

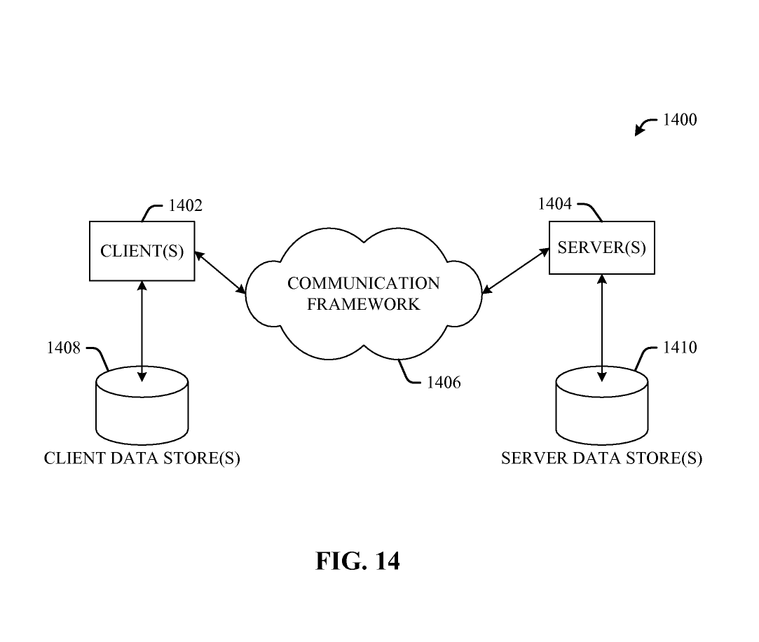

Referring now to FIG. 14, there is illustrated a schematic block diagram of an exemplary computer compilation system operable to execute the disclosed architecture. The system 1400 includes one or more client(s) 1402. The client(s) 1402 can be hardware such as a digital camera with computer interface support and/or software (e.g., threads, processes, computing devices). The client(s) 1402 can house cookie(s) and/or associated contextual information by employing the claimed subject matter, for example.

The system 1400 also includes one or more server(s) 1404. The server(s) 1404 can also be hardware and/or software (e.g., threads, processes, computing devices). The servers 1404 can house threads to perform transformations by employing the claimed subject matter, for example. One possible communication between a client 1402 and a server 1404 can be in the form of a data packet adapted to be transmitted between two or more computer processes. The data packet may include a cookie and/or associated contextual information, for example. The system 1400 includes a communication framework 1406 (e.g., a global communication network such as the Internet) that can be employed to facilitate communications between the client(s) 1402 and the server(s) 1404.

Communications can be facilitated via a wired (including optical fiber) and/or wireless technology. The client(s) 1402 are operatively connected to one or more client data store(s) 1408 that can be employed to store information local to the client(s) 1402 (e.g., cookie(s) and/or associated contextual information). Similarly, the server(s) 1404 are operatively connected to one or more server data store(s) 1410 that can be employed to store information local to the servers 1404.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” and “including” are used in either the detailed description or the claims, such term is intended to be inclusive in a manner similar to the term “comprising” as “comprising” is interpreted when employed as a transitional word in a claim.

What is claimed is:

1. A system that provides convenient and economical access to location information, comprising:
a portable electronic device; and
a location-enabled device that communicates with the portable electronic device and determines a location of the portable electronic device based at least in part upon a location of the location-enabled device.

2. The system of claim 1, the location-enabled device communicates wirelessly with the portable electronic device.

3. The system of claim 1, the location-enabled device is at least one of a kiosk and a portable device.

4. The system of claim 1, the location of the location-enabled device is determined based upon at least one of a global positioning system (GPS), an assisted GPS, a global system for mobile communications localization, radiolocation, information from a second location-enabled device, and a fixed address location.

5. The system of claim 1, the location of the portable electronic device is determined based upon at least one of triangulation, maximum transmission range, radiolocation and information from a second location-enabled device.

6. The system of claim 1, the location-enabled device transmits the location of the portable electronic device to the portable electronic device.

7. The system of claim 1, the location-enabled device transmits the location of the portable electronic device to the portable electronic device in exchange for an incentive.

8. The system of claim 7, the incentive is at least one of money, a credit, a debit, a coupon, a reward point, an advertisement right, a location resale right, an access right, a product and a service.

9. The system of claim 1, the location-enabled device transmits to a third device location information associated with the portable electronic device.

10. The system of claim 9, the third device employs the location information to determine that the portable electronic device is within close proximity to at least one of the location-enabled device and the third device.

11. The system of claim 9, the location-enabled device transmits the location information when the portable electronic device leaves a designated vicinity.

12. The system of claim 1, the location-enabled device broadcasts a signal that indicates a desire to transmit location information.

13. The system of claim 1, the location-enabled device provides location information upon a pull request from the portable electronic device.

14. The system of claim 1, the location-enabled device is an radio frequency (RF)-enabled stereo.

15. A computer-implemented method for facilitating location-based services for devices that are not location-enabled, comprising:
establishing a connection between a location-enabled device and a portable device;
determining a location of the portable device based at least in part upon a position of the location-enabled device; and
providing an incentive for sharing information associated with the location.

16. The method of claim 15, further comprising employing radiolocation to increase the accuracy of the location.

17. The method of claim 15, further comprising sharing the information with at least one of the portable device and a third device.

18. The method of claim 15, the establishing a connection is a result of at least one of a push transaction and a pull transaction.

19. The method of claim 15, further comprising employing the location in connection with an application.

20. A system for facilitating location-based services, comprising:
means for providing an incentive to share location information;
means for accurately determining a location of a mobile device; and
means for communicating the location information.
